(19) United States
(12) Patent Application Publication
(10) Pub. No.: US 2020/0370433 A1
(43) Pub. Date: Nov. 26, 2020

(54) RISK EVALUATION METHOD OF OVERBURDEN BED-SEPARATION WATER DISASTER IN MINING AREA

(71) Applicant: China University of Mining and Technology, Jiangsu (CN)

(72) Inventors: Wenping LI, Jiangsu (CN); Kaifang FAN, Jiangsu (CN); Qiqing WANG, Jiangsu (CN); Xiaoqin LI, Jiangsu (CN); Dongliang ZHAO, Jiangsu (CN)

(73) Assignee: China University of Mining and Technology, Jiangsu (CN)

(21) Appl. No.: 16/630,462

(22) PCT Filed: Jan. 25, 2019
(86) PCT No.: PCT/CN2019/073153

§ 371 Date: Jan. 12, 2020

(30) Foreign Application Priority Data
Jun. 8, 2018 (CN) 201810583414.X

(51) Int. Cl. E21C 41/18; E21B 49/00; G01N 3/12; G06Q 10/06

(52) U.S. Cl. CPC E21C 41/18; E21B 49/003; G06Q 50/02; G06Q 10/0635; G01N 3/12

(57) ABSTRACT

The present invention relates to the field of prevention of a water disaster in coal mining, and discloses a risk evaluation method of an overburden bed-separation water disaster in a mining area. In the prior art, prevention of the bed-separation water disaster is achieved mainly by making bed-separation water “cut-off holes” and “diversion holes” underground; however, the degree of a roof bed-separation water disaster in the mining area has not yet been qualitatively or quantitatively evaluated and analyzed, resulting in blindness of the prevention of the bed-separation water disaster. In order to solve this problem, the present invention provides a risk evaluation method of an overburden bed-separation water disaster in a mining area, which includes the following steps: S1. collecting geological information about strata in the mining area; S2. calculating the height of a water-conducting fissure zone in the mining area; S3. based on a composite beam principle, determining a bed separation development position in strata above the water-conducting fissure zone; and S4. calculating a bed-separation water inrush coefficient, and zoning the mining area based on a risk of an overburden bed-separation water disaster. The present invention can predict and evaluate a risk of an overburden bed-separation water disaster in the mining area in advance, thus providing a scientific basis for designing a scheme to prevent the bed-separation water disaster, and guaranteeing coal mining safety.

### FIELD OF THE INVENTION

The present invention relates to the field of prevention of a water disaster in coal mining, and in particular, to a risk evaluation method of an overburden bed-separation water disaster in a mining area.

### DESCRIPTION OF RELATED ART

As the working face advances in coal mining, overburden bed separation gradually develops in a mining area, accompanied by replenishment from the overburden aquifer to bed separation space. With the rise in accumulation of bed-separation water and deformation of the overburden, under certain conditions, the strata below the bed separation space are broken, and water gushes out of bed-separation cavities, resulting in a bed-separation water inrush. A bed-separation water disaster is a special water disaster type, which is characterized by a massive burst of water, an unobvious water inrush sign, and periodical occurrence of a roof water inrush, often causing great damage and harm. For example, on May 21, 2006, a bed-separation water inrush occurs in the Haizi coal mine, Huaibei coalfield. Strong water flows of 3887 m³/h carrying gangue of nearly 500 m³ instantly gush out, and flood the working face, machine tunnel, and wind lane, incurring death of five workers.

Currently, prevention of the bed-separation water disaster is achieved mainly by making bed-separation water “cut-off holes” and “diversion holes” underground. However, the degree of risk of a roof bed-separation water disaster in the mining area has not yet been qualitatively or quantitatively evaluated and analyzed, resulting in blindness of the prevention of the bed-separation water disaster.

### BRIEF SUMMARY OF THE INVENTION

In view of the foregoing analysis, the present invention aims to provide a risk evaluation method of an overburden bed-separation water disaster in a mining area, so as to solve the technical problem that the existing prevention of the bed-separation water disaster has blindness.

The objective of the present invention is mainly achieved by using the following technical solution:

The present invention provides a risk evaluation method of an overburden bed-separation water disaster in a mining area, which includes the following steps:

S1. Geological information about strata in the mining area is collected, including: a borehole histogram, a water head pressure of a bed-separation water filling source, strata thicknesses, elastic moduli, and strata unit weights. The borehole histogram is an engineering geological map compiled for the purpose of describing stratification, thickness, lithology, and structural compositions of strata through which a borehole passes and a contact relationship therebetween, groundwater sampling and testing, a borehole structure, a drilling operation, and other conditions. It is an important basis for analyzing engineering geological conditions and drawing a geological profile. It should be noted that, the borehole histogram, the water head pressure of the bed-separation water filling source, and the strata thicknesses are basic data in the field of geological technology. Geological workers obtain these basic data through hydrogeological exploration in the early-stage mine construction process. Therefore, those skilled in the art can directly obtain these data. Moreover, the elastic modulus of the strata can be directly acquired by using a testing device. For example, an all-digital hydraulic servo testing machine MTS815 is used to test a rock sample, and then the elastic modulus can be directly obtained. The test principle is that, the testing machine obtains a rock axial stress-strain curve, and the elastic modulus is determined according to the average slope of approximately straight line segments on the curve, which is expressed as follows:

$$E = \frac{Δσ}{{Δɛ}_{i}}$$

In the formula, E, in MPa, is the elastic modulus of the tested rock, namely, the elastic modulus of a stratum where the rock is located; Δσ is the stress of the approximately straight line segments on the curve, in MPa; and Δεᵢ is the strain of the approximately straight line segments on the curve.

The stratum unit weight can be acquired by testing the rock by means of indoor volume measurement, which is as follows:

γ=G/V

In the formula, γ, in kN/m³, is the rock unit weight, namely, the unit weight of a stratum where the rock is located; G is the weight of the rock, in kN; and V is the volume of the rock, in m³.

S2. The height of a water-conducting fissure zone in the mining area is calculated. Specifically, a development height of the water-conducting fissure zone in the mining area is calculated by using a formula in Exploration Specification of Hydrogeology and Engineering Geology in Mining Areas.

S3. Based on a composite beam principle, a bed separation development position in strata above the water-conducting fissure zone is determined according to the strata thicknesses, the elastic moduli, and the strata unit weights which are collected in step S, which includes the following steps:

S31. successively numbering the strata above the water-conducting fissure zone as 1, 2, . . . n from top to bottom according to the borehole histogram;

S32. when the n-layer strata synchronously deform in the form of a composite beam to cause load redistribution, calculating an actual load (qₙ)₁ carried by the bottom stratum (namely, the first layer of the composite beam) according to the following formula:

$${( {q}_{n} )}_{1} = \frac{{E}_{1} {h}_{1}^{3} ( {γ}_{1} {h}_{1} + {γ}_{2} {h}_{2} + … + {γ}_{n} {h}_{n} )}{{E}_{1} {h}_{1}^{3} + {E}_{2} {h}_{2}^{3} + … + {E}_{n} {h}_{n}^{3}}$$

where in the formula, qₙ is the actual load carried by a stratum, in kPa; E is the elastic modulus, in MPa; h is the stratum thickness, in m; and γ is the stratum unit weight, in kN/m³; and

S33. if (qₘ)₁=max ((q₁)₁, (q₂)₁ . . . , (qₙ)₁) and 1≤m<n, determining that bed separation occurs between the (m+1)th stratum and the mth stratum; or if (qₙ)₁=max ((q₁)₁, (q₂)₁ . . . , (qₙ)₁), determining that there is no bed-separation cavity from the strata No. 1 to No. n.

S4. A bed-separation “water inrush coefficient” is calculated, and the mining area is zoned based on a risk of a bed-separation water disaster, which includes the following steps:

S41. calculating a bed-separation “water inrush coefficient” of each drilling point according to the following formula:

$$T = \frac{P}{H}$$

where in the formula, T is the water inrush coefficient, in MPa/m; P is the water head pressure of the bed-separation water filling source, in MPa; and H is the thickness of strata between the bed-separation cavity and the water-conducting fissure zone, in m;

S42: drawing a contour map regarding the bed-separation “water inrush coefficients” in the mining area according to a calculation result of the bed-separation “water inrush coefficient” of each drilling point;

S43. determining a critical water inrush coefficient Tₛ by means of a statistical analysis on actual bed-separation water inrush information of the mining area; or if the actual bed-separation water inrush information of the mining area is limited or absent, setting Tₛ to 0.06 MPa/m according to Coal Mine Water Control Regulations; and

S44. classifying a zone of which the water inrush coefficient T is less than the critical water inrush coefficient Tₛ as a safe region, while classifying a zone of which the water inrush coefficient T is greater than the critical water inrush coefficient Tₛ as a danger region at risk of a bed-separation water disaster.

As compared with the prior art, the present invention achieves the following advantageous effects:

The present invention provides a risk evaluation method of an overburden bed-separation water disaster in a mining area. The height of a water-conducting fissure zone is calculated, a bed separation development position is determined, a bed-separation water inrush coefficient of each drilling point is calculated, and the mining area is zoned into a safe region from the bed-separation water disaster and a danger region at risk of the bed-separation water disaster. Thus, the degree of the risk of a roof bed-separation water disaster in the mining area can be qualitatively and quantitatively evaluated and analyzed. The conventional method for determining a bed separation development position not only can be modified, but also prevention of the bed-separation water disaster has definite orientations. By prediction about the risk of a bed-separation water disaster in the mining area, a scheme to prevent the bed-separation water disaster can be designed according to a prediction result in the mining area, thus guaranteeing coal mining safety.

In the present invention, the technical solutions can be mutually combined to implement more preferred combined solutions. Other features and advantages of the present invention will be described later in the specification. Some of the advantages may be apparent from the specification or may be understood by implementing the present invention. The objective and other advantages of the present invention can be achieved and obtained from contents specified in the specification, claims, and accompanying drawings

### BRIEF DESCRIPTION OF THE DRAWINGS

The accompanying drawings are only for the purpose of illustrating a specific embodiment, and are not considered as a limitation to the present invention. In all the accompanying drawings, identical numerals indicate identical parts.

FIG. 1 is a flowchart of implementation of a risk evaluation method of an overburden bed-separation water disaster in a mining area according to the present invention;

FIG. 2 shows a result of zoning a mining area in a coal mine in Northwest China based on a risk of an overburden bed-separation water disaster; and

FIG. 3 is a diagram showing an actual water inrush quantity during mining on a working face in the coal mine in Northwest China.

### DETAILED DESCRIPTION OF THE INVENTION

A preferred embodiment of the present invention is specifically described with reference to the accompanying drawings. The accompanying drawings form a part of the present application and are used to illustrate the principle of the present invention together with the embodiment of the present invention and are not intended to limit the scope of the present invention.

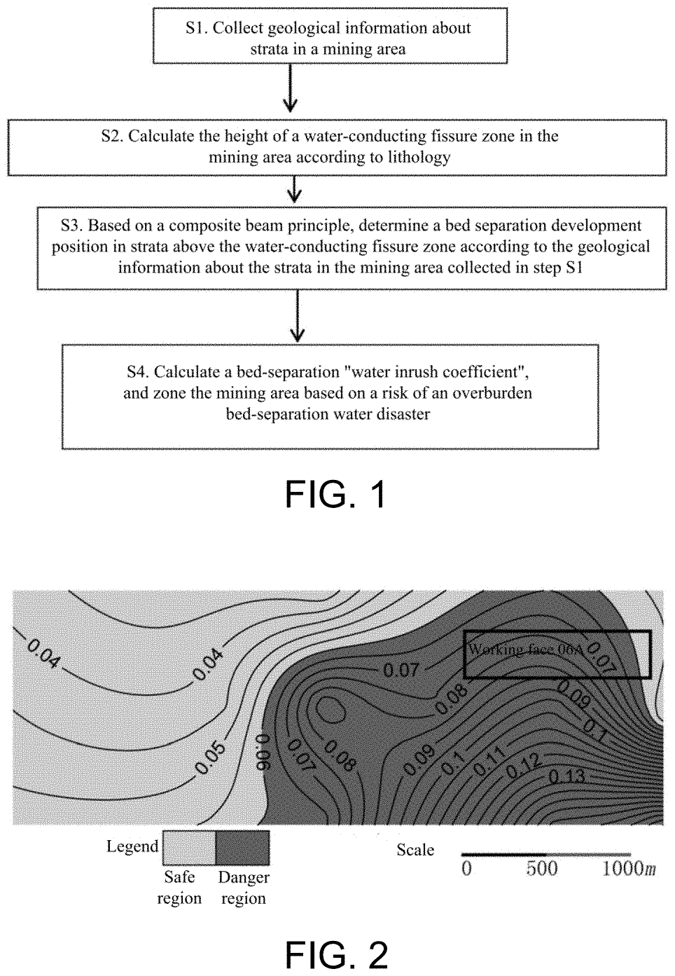

The present invention provides a risk evaluation method of an overburden bed-separation water disaster in a mining area. As shown in FIG. 1, the method includes the following steps:

S1. Geological information about strata in the mining area is collected. The geological information about the mining area is actually acquired by means of drilling and rock mechanics, including: a borehole histogram, a water head pressure of a bed-separation water filling source, strata thicknesses, elastic moduli, and strata unit weights. The borehole histogram is an engineering geological map compiled for the purpose of describing stratification, thickness, lithology, and structural compositions of strata through which a borehole passes and a contact relationship therebetween, groundwater sampling and testing, a borehole structure, a drilling operation, and other conditions. It is an important basis for analyzing engineering geological conditions and drawing a geological profile. It should be noted that, the borehole histogram, the water head pressure of the bed-separation water filling source, and the strata thicknesses are basic data in the field of geological technology. Geological workers obtain these basic data through hydrogeological exploration in the early-stage mine construction process. Therefore, those skilled in the art can directly obtain these data. Moreover, the elastic modulus of the strata can be directly acquired by using a testing device. For example, an all-digital hydraulic servo testing machine MTS815 is used to test a rock sample, and then the elastic modulus can be directly obtained. The test principle is that, the testing machine obtains a rock axial stress-strain curve, and the elastic modulus is determined according to the average slope of approximately straight line segments on the curve, which is expressed as follows:

$$E = \frac{Δσ}{{Δɛ}_{i}}$$

In the formula, E, in MPa, is the elastic modulus of the tested rock, namely, the elastic modulus of a stratum where the rock is located; Δσ is the stress of the approximately straight line segments on the curve, in MPa; and Δεᵢ is the strain of the approximately straight line segments on the curve.

The stratum unit weight can be acquired by testing the rock by means of indoor volume measurement, which is as follows:

γ=G/V

In the formula, γ, in kN/m³, is the unit weight of the rock, namely, the unit weight of a stratum where the rock is located; G is the weight of the rock, in kN; and V is the volume of the rock, in m³.

S2. The height of a water-conducting fissure zone in the mining area is calculated according to Exploration Specification of Hydrogeology and Engineering Geology in Mining Areas.

S3. Based on a composite beam principle, a bed separation development position in strata above the water-conducting fissure zone is determined according to the strata thicknesses, the elastic moduli, and the strata unit weights which are collected in step S1. A determining process includes the following steps:

S31. The strata above the water-conducting fissure zone are successively numbered as 1, 2, . . . n from top to bottom according to the borehole histogram.

S32. When the n-layer strata synchronously deform in the form of a composite beam to cause load redistribution, an actual load (qₙ)₁ carried by the bottom stratum (namely, the first layer of the composite beam) is calculated according to the following formula:

$${( {q}_{n} )}_{1} = \frac{{E}_{1} {h}_{1}^{3} ( {γ}_{1} {h}_{1} + {γ}_{2} {h}_{2} + … + {γ}_{n} {h}_{n} )}{{E}_{1} {h}_{1}^{3} + {E}_{2} {h}_{2}^{3} + … + {E}_{n} {h}_{n}^{3}}$$

In the formula, qₙ is the actual load carried by a stratum, in kPa; E is the elastic modulus, in MPa; h is the stratum thickness, in m; and γ is the stratum unit weight, in kN/m³.

S33. If (qₘ)₁=max ((q₁)₁, (q₂)₁ . . . , (qₙ)₁) and 1≤m<n, it is determined that bed separation occurs between the (m+1)th stratum and the mth stratum; or if (qₙ)₁=max ((q₁)₁, (q₂)₁ . . . , (qₙ)₁), it is determined that there is no bed-separation cavity from the strata No. 1 to No. n.

S4. A bed-separation “water inrush coefficient” is calculated, and the mining area is zoned based on a risk of a bed-separation water disaster.

The zoning the mining area based on the risk of a bed-separation water disaster includes the following steps: S41. A bed-separation “water inrush coefficient” of each drilling point is calculated according to the following formula:

$$T = \frac{P}{H}$$

In the formula, T is the water inrush coefficient, in MPa/m; P is the water head pressure of the bed-separation water filling source, in MPa; and H is the thickness of strata between the bed-separation cavity and the water-conducting fissure zone, in m.

S42: A contour map regarding the bed-separation “water inrush coefficients” in the mining area is drawn according to a calculation result of the bed-separation “water inrush coefficient” of each drilling point.

S43. A critical water inrush coefficient Tₛ is determined by means of a statistical analysis on actual bed-separation water inrush information of the mining area. If the actual bed-separation water inrush information of the mining area is limited or absent, Tₛ is set to 0.06 MPa/m according to Coal Mine Water Control Regulations.

S44. A zone of which the water inrush coefficient T is less than the critical water inrush coefficient Tₛ is classified as a safe region, while a zone of which the water inrush coefficient T is greater than the critical water inrush coefficient Tₛ is classified as a danger region at risk of a bed-separation water disaster.

### Embodiment 1

In a coal mine in Northwest China, a working face 06A has a width of 290 m and a running length of 1100 m. An initially mined coal seam 2-2 is nearly flat, with an average burial depth of 650 m and an average mining thickness of 9.1 m. A mining mode is fully-mechanized caving mining. Information about boreholes in and around the working face is collected, and the height of a water-conducting fissure zone is calculated by using an empirical formula related to hard rocks in Exploration Specification of Hydrogeology and Engineering Geology in Mining Areas. Some calculation results are shown in Table 1. A specific formula is as follows:

$${H}_{f} = \frac{100 M}{2.4 n + 2.1} + 11.2$$

In the formula, H_{f} is the height of the water-conducting fissure zone, in m; M is an accumulative mining thickness of the coal seam, in m; and n is the number of layers of the coal seam.

TABLE 1
Normalized calculated values of the height of the water-conducting
fissure zone

| | | Height (m) of the | Ratio of the height of |
|---|---|---|---|
| Hole | Mining | water-conducting | the fractured zone to the |
| numbers | thickness | fissure zone | mining height |
| K39 | 10.16 | 236.02 | 23.23 |
| K40 | 10.78 | 250.76 | 23.26 |
| K46 | 10.23 | 239.69 | 23.43 |
| K47 | 10.23 | 238.53 | 23.32 |
| K54 | 9.92 | 240.81 | 23.54 |
| K55 | 9.85 | 230.09 | 23.35 |
| K62 | 8.70 | 204.53 | 23.51 |
| K72 | 9.10 | 216.30 | 23.77 |

When the n-layer strata synchronously deform in the form of a composite beam to cause load redistribution, an actual load (qₙ)₁ carried by the bottom stratum (namely, the first layer of the composite beam) is calculated according to the following formula:

$${( {q}_{n} )}_{1} = \frac{{E}_{1} {h}_{1}^{3} ( {γ}_{1} {h}_{1} + {γ}_{2} {h}_{2} + … + {γ}_{n} {h}_{n} )}{{E}_{1} {h}_{1}^{3} + {E}_{2} {h}_{2}^{3} + … + {E}_{n} {h}_{n}^{3}}$$

If (qₘ)₁=max ((q₁)₁, (q₂)₁ . . . , (qₙ)₁) and 1≤m<n, it indicates that the strata No. 1 to No. m are able to synchronously curve and deform in the form of a “composite beam”, but the strata No. m+1 and No. m are unable to synchronously curve and deform. Thus, it can be determined that bed separation occurs between the (m+1)th stratum and the mth stratum.

If (qₙ)₁=max ((q₁)₁, (q₂)₁ . . . , (qₙ)₁), it indicates that the strata No. 1 to No. n are able to synchronously curve and deform in the form of a “composite beam”. Thus, it can be determined that there is no bed-separation cavity from the strata No. 1 to No. n.

By using the borehole K40 as an example, a bed separation development position in strata above the water-conducting fissure zone is theoretically determined according to the foregoing formula, and determination results are shown in Table 2.

TABLE 2
Theoretical determination results regarding a bed separation development position (for the borehole K40)

| | | | | | | | Does bed | | | | Does bed |
|---|---|---|---|---|---|---|---|---|---|---|---|
| | | | | | | | separation | | Does bed | | separation |
| | | | | Strata | Elastic | | develop | | separation | | develop |
| | Serial | | Strata | unit | modulus | | in the | | develop in | | in the |
| Stratigraphic | numbers | | thick- | weight | (10³ | (qₙ)₁ | lower | (qₙ)₄ | the lower | | lower |
| position | of strata | Lithology | ness(m) | (kN/m³) | MPa) | (kPa) | part? | (kPa) | part? | (qₙ)₅(kPa) | part? |
| Luohe | 8 | Medium | 17.53 | 25.7 | 10 | 266.54 | — | 372.25 | — | 1674.93 | No |
| formation of | | sandstone | | | | | | | | | |
| Cretaceous | 7 | Fine | 31.65 | 25.4 | 18 | 248.75 | — | 335.73 | — | 1468.57 | No |
| system | | sandstone | | | | | | | | | |
| | 6 | Medium | 32.52 | 23.2 | 9 | 267.60 | — | 342.60 | — | 1428.50 | No |
| | | sandstone | | | | | | | | | |
| | 5 | Fine | 44.08 | 24.3 | 13 | 257.75 | — | 295.40 | Yes | 1071.14 | — |
| | | sandstone | | | | | | | | | |
| | 4 | Medium | 28.2 | 24.5 | 10 | 620.95 | Yes | 690.90 | — | — | — |
| | | sandstone | | | | | | | | | |
| | 3 | Sandy | 9.2 | 23.4 | 4 | 835.67 | No | — | — | — | — |
| | | mudstone | | | | | | | | | |
| | 2 | Medium | 21 | 23.1 | 10 | 721.15 | No | — | — | — | — |
| | | sandstone | | | | | | | | | |
| Jurassic | 1 | Sandy | 32 | 23.3 | 4 | 745.60 | No | — | — | — | — |
| system | | mudstone | | | | | | | | | |

| | | | | |
|---|---|---|---|---|
| Anding | — | Mudstone | 5.3 | The water-conducting fissure zone is entered |

formation

By using the stratum No. 1 as the first layer of the composite beam, a bed separation development position in strata above the stratum No. 1 is first determined. A calculation result indicates that:

max((q₁)₁,(q₂)₁ . . . ,(q₈)₁)=(q₃)₁=835.67 kPa

Thus, it can be determined that a bed-separation cavity is produced between the strata No. 4 and No. 3.

Next, a bed separation development position in strata above the stratum No. 4 is determined. Because bed separation already occurs between the strata No. 4 and No. 3, the stratum No. 4 is used as the first layer of the composite beam to make a determination, and a calculation result indicates that:

max((q₄)₄,(q₅)₄ . . . ,(q₈)₄)=(q₄)₄=690.90 kPa

Thus, it can be determined that a bed-separation cavity is produced between the strata No. 5 and No. 4.

Afterwards, a bed separation development position in strata above the stratum No. 5 is determined. Because bed separation already occurs between the strata No. 5 and No. 4, the stratum No. 5 is used as the first layer of the composite beam to make a determination, and a calculation result indicates that:

max(q₈)₈,(q₆)₆ . . . ,(q₈)₈)=(q₈)₈=1674.93 kPa

Thus, it can be determined that there is no bed-separation cavity between the strata No. 5 and No. 8.

The determination results show that, a bed-separation cavity closest to the top boundary of the water-conducting fissure zone is located in the lower part of the Luohe formation, between the medium sandstone No. 4 and the sandy mudstone No. 3. It is 63.08 m distant from the water-conducting fissure zone. The hydraulic pressure in the Luohe formation is 3.2 MPa according to geological information about the borehole K40. Then, a water inrush coefficient is calculated as follows:

$$T = \frac{P}{H} = \frac{3.2}{63.08} \approx 0.051 MPa \text{/} m$$

Likewise, bed separation development positions are theoretically determined for other boreholes, and bed-separation water inrush coefficients are calculated. Some results are shown in Table 3.

TABLE 3
Theoretic calculated values of bed-separation water inrush coefficients

| | Water head | Thickness (m) of | |
|---|---|---|---|
| | pressure (MPa) | strata between the | |
| | of a | bed-separation | |
| | bed-separation | cavity and the | Water inrush |
| Hole | water | water-conducting | coefficient |
| No. | filling source | fissure zone | (MPa/m) |
| K39 | 2.9 | 16.52 | 0.175 |
| K40 | 3.2 | 63.08 | 0.051 |
| K46 | 3.7 | 65.35 | 0.056 |
| K47 | 2.9 | 28.35 | 0.102 |
| K54 | 2.8 | 18.19 | 0.156 |
| K55 | 2.8 | 42.72 | 0.065 |
| K61 | 2.8 | 44.79 | 0.062 |
| K62 | 2.7 | 34.36 | 0.079 |

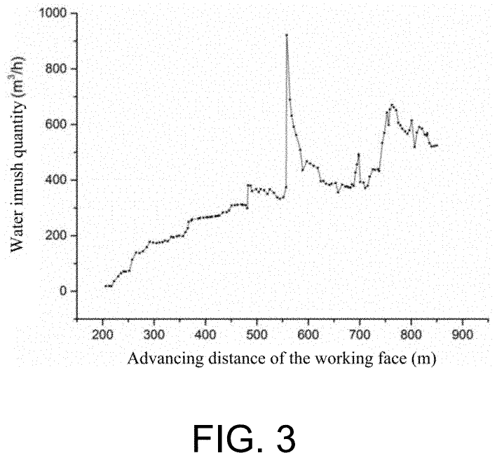

According to borehole orifice coordinates and mining area boundary coordinates, a contour map regarding the bed-separation water inrush coefficients in the mining area is drawn by using sufferr software. A critical water inrush coefficient Tₛ is set to 0.06 MPa/m according to Coal Mine Water Control Regulations. A zone of which the water inrush coefficient T is less than 0.06 MPa/m is classified as a safe region, while a zone of which the water inrush coefficient T is greater than 0.06 MPa/m is classified as a danger region at risk of a bed-separation water disaster. A zoning result is shown in FIG. 2. According to a mining practice in the mining area, when the working face 06A advances by 558 m, a roof water inrush instantaneously occurs, and the maximum water inrush quantity reaches up to 921.4 m³/h. As shown in FIG. 3, a bed-separation water inrush feature is obvious, which indicates that mining on the working face 06A is at risk of an overburden bed-separation water disaster, and further verifies that a risk evaluation result of the overburden bed-separation water disaster conforms to an actual situation.

The above merely describes a preferred embodiment of the present invention, but the protection scope of the present invention is not limited thereto. Changes or replacements easily conceived by any person skilled in the art within the technical scope of the present invention all fall within the protection scope of the present invention.

1. A risk evaluation method of an overburden bed-separation water disaster in a mining area, comprising the following steps:
S1. collecting geological information about strata in the mining area;
S2. calculating a height of a water-conducting fissure zone in the mining area according to lithology;
S3. based on a composite beam principle, determining a bed separation development position in strata above the water-conducting fissure zone according to the geological information about the strata in the mining area collected in step S1; and
S4. calculating a bed-separation water inrush coefficient, and zoning the mining area based on a risk of an overburden bed-separation water disaster.

2. The risk evaluation method of an overburden bed-separation water disaster in a mining area according to claim 1, wherein in step S1, the collecting the geological information about the strata in the mining area is collecting the following physical parameters of the strata in the mining area: a borehole histogram, a water head pressure of a bed-separation water filling source, strata thicknesses, elastic moduli, and strata unit weights.

3. The risk evaluation method of an overburden bed-separation water disaster in a mining area according to claim 2, wherein in step S3, based on the composite beam principle, the bed separation development position in strata above the water-conducting fissure zone is determined according to the geological information about the strata in the mining area collected in step S1; and a method for determining the bed separation development position comprises:
S31. successively numbering the strata above the water-conducting fissure zone as 1, 2, . . . n, where n≥1, from top to bottom according to the borehole histogram; and
S32. when the n-layer strata synchronously deform in the form of a composite beam to cause load redistribution, calculating an actual load (qₙ)₁ carried by the bottom stratum which is the first layer of the composite beam, according to the following formula:
$${( {q}_{n} )}_{1} = \frac{{E}_{1} {h}_{1}^{3} ( {γ}_{1} {h}_{1} + {γ}_{2} {h}_{2} + … + {γ}_{n} {h}_{n} )}{{E}_{1} {h}_{1}^{3} + {E}_{2} {h}_{2}^{3} + … + {E}_{n} {h}_{n}^{3}}$$
wherein in the formula, q is the actual load carried by a stratum, in kPa; E is the elastic modulus, in MPa; h is the stratum thickness, in m; and γ is the stratum unit weight, in kN/m³.

4. The risk evaluation method of an overburden bed-separation water disaster in a mining area according to claim 3, wherein in step S32, in the method for determining the bed separation development position, if (qₘ)₁=max ((q₁)₁, (q₂)₁ . . . , (qₙ)₁) and 1≤m<n, it is determined that bed separation occurs between the (m+1)th stratum and the mth stratum, and a bed-separation cavity exists.

5. The risk evaluation method of an overburden bed-separation water disaster in a mining area according to claim 3, wherein in step S32 in the method for determining the bed separation development position, if (qₙ)₁=max ((q₁)₁, (q₂)₁ . . . , (qₙ)₁), it is determined that there is no bed-separation cavity from the strata No. 1 to No. n.

6. The risk evaluation method of an overburden bed-separation water disaster in a mining area according to claim 1, wherein the step S4 of calculating the bed-separation water inrush coefficient, and zoning the mining area based on a risk of an overburden bed-separation water disaster comprises:
S41. calculating bed-separation water inrush coefficients;
S42. drawing a contour map regarding an overburden bed-separation water inrush coefficients in the mining area according to a calculation result of the bed-separation water inrush coefficient of each drilling point;
S43. determining a critical water inrush coefficient Tₛ by means of a statistical analysis on actual bed-separation water inrush information of the mining area; and
S44. comparing the bed-separation water inrush coefficients T with the critical water inrush coefficient Tₛ, and zoning the mining area into a danger region at risk of the bed-separation water disaster and a safe region from the bed-separation water disaster.

7. The risk evaluation method of an overburden bed-separation water disaster in a mining area according to claim 6, wherein in step S41, the bed-separation water inrush coefficient is calculated according to the following formula:
$$T = \frac{P}{H}$$
wherein in the formula, T is the water inrush coefficient, in MPa/m; P is the water head pressure of the bed-separation water filling source, in MPa; and H is the thickness of strata between the bed-separation cavity and the water-conducting fissure zone, in m.

8. The risk evaluation method of an overburden bed-separation water disaster in a mining area according to claim 6, wherein in step S43, if the actual bed-separation water inrush information of the mining area is limited or absent, Tₛ is set to 0.06 MPa/m.

9. The risk evaluation method of an overburden bed-separation water disaster in a mining area according to claim 7, wherein in step S44, a zone of which the water inrush coefficient T is less than the critical water inrush coefficient Tₛ is classified as a safe region.

10. The risk evaluation method of an overburden bed-separation water disaster in a mining area according to claim 7, wherein in step S44, a zone of which the water inrush coefficient T is greater than the critical water inrush coefficient Tₛ is classified as a danger region at risk of the bed-separation water disaster.
